(19) United States
(12) Patent Application Publication
(10) Pub. No.: US 2008/0018114 A1
(43) Pub. Date: Jan. 24, 2008

(54) Harvesting and transporting energy from water wave action to produce electricity hydraulically within a floating ship or vessel

(76) Inventor: Ken Weldon, Salem, OR (US)

Correspondence Address: Ken Weldon, 334 Calico St. NW, Salem, OR, 97304, US

(21) Appl. No.: 11/818,939

(22) Filed: Jun. 18, 2007

Related U.S. Application Data
(60) Provisional application No. 60/832,550, filed on Jul. 24, 2006.

(51) Int. Cl. F03B 13/10

(52) U.S. Cl. 290/53

(57) ABSTRACT

This is a unique way for an anchored vessel at sea near an isolated island or outpost to be able to generate electricity and transfer it from within its hull for use onshore with an electrical underwater cable for that community.

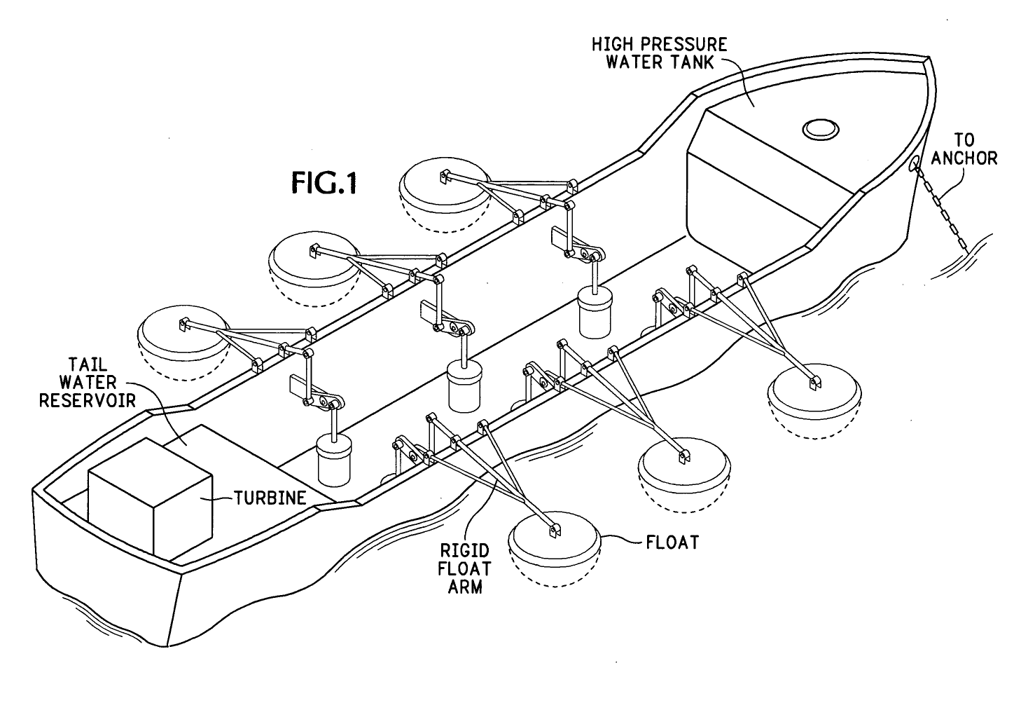

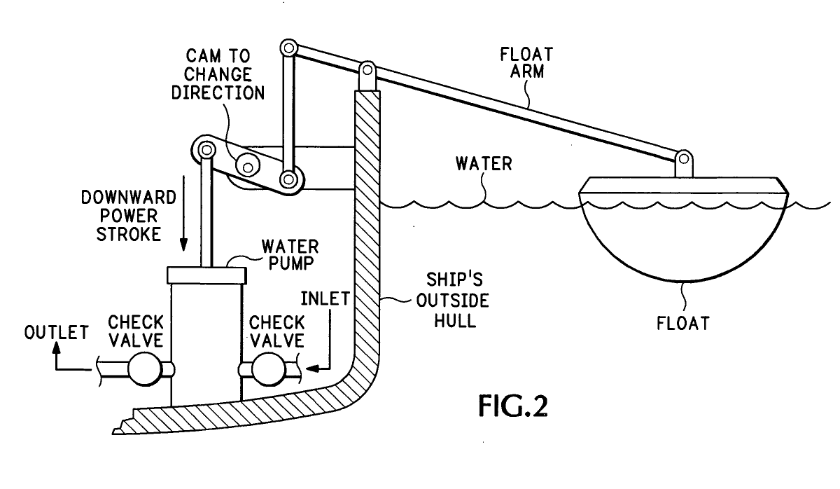

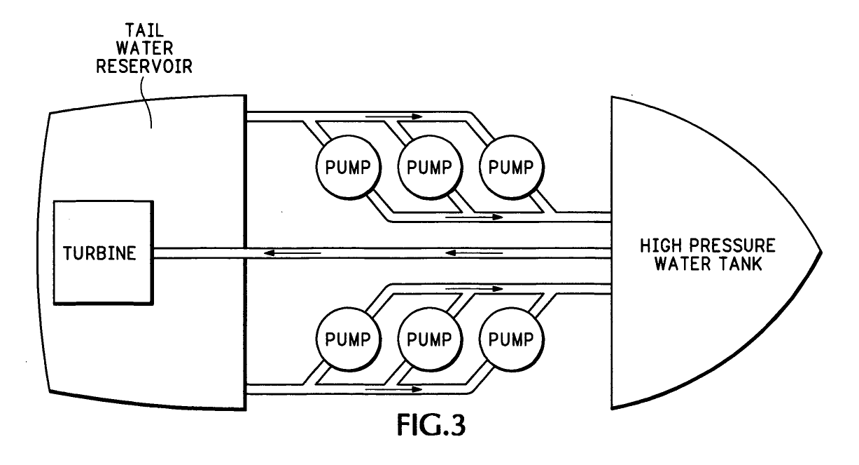

The floating vessel, or electrical station, is unique because it is anchored in water wave action and has a total of (six) side floats, moving up and down from water waves and these floats and float arms are used as simple lever machines rotating on the ship's bow to transfer this energy to fresh and recycled water inside the vessel by means of a water piston and water pipes into a pressurized water tank for turning a water turbine there, then recycling or pumping this water again, and again for generating electricity within the body of this floating vessel.

### (REFER TO PREVIOUS PROVISIONAL) U.S. 60/832550

This is a utility patent application

### CROSS REFERENCE TO SOME RELATED PATENT APPLICATIONS ARE

U.S. patent numbers:
U.S. Pat. No. 4,319,454—Mar. 16, 1982 (Perhaps the nearest likeness)
U.S. Pat. No. 228,860—Oct. 14, 1980 & Jun. 8, 1979
U.S. Pat. No. 5,027,000—Sep. 7, 1989
U.S. Pat. No. 4,185,947—Dec. 28, 1977
U.S. Pat. No. 3,664,125—Mar. 30, 1970
U.S. Pat. No. 3,746,875—Aug. 4, 1972
U.S. Pat. No. 4,851,704—Oct. 17, 1988
U.S. Pat. No. 4,023,041—Mar. 1, 1976
U.S. Pat. No. 3,012,938—Jan. 25, 1974
U.S. Pat. No. 4,091,618—Jan. 14, 1976
U.S. Pat. No. 4,627,240—Feb. 27, 1981
U.S. Pat. No. 4,719,158—Mar. 27, 1987
U.S. Pat. No. 3,959,663—Oct. 19, 1974
U.S. Pat. No. 4,563,591—Jan. 7, 1986
U.S. Pat. No. 4,389,843—Jun. 28, 1983

### BACKGROUND OF INVENTION

This final invention has come from ideas I originally conceived in the 1960's while boating in the Pacific Ocean off the coast of the states of Oregon and Washington, U.S.A. I then started to develop a way to capture some of the energy of water wave action to produce electricity. To show an earlier time of conception before today's date, I started certified mailings to myself beginning Feb. 19, 1999 that verifies work progress in the years of 1995 and 1996. I have several certified mailings to myself since to show my progress on this invention.

In earlier conceptions of this invention I was trying to carry this electric generating station only on a fixed support from the floor of the ocean or body of water, as well as trying to harvest tide and current action at the same time.

In 2002, I was using mechanical means with wire cables and rotating cylinder to transfer the energy to the generator, but now have the new idea of using only hydraulic energy to turn the generator within the body of a vessel.

My latest conception includes the new way to harvest water wave energy by using a specially constructed float, plus the use of a water reservoir and water pump within the vessel's hull to receive and transport energy to the generator located also in the hull for production of electricity. My invention submitted herewith requires a floating vessel to carry the electrical generating station.

### BRIEF SUMMARY OF THE INVENTION

The object of this invention is to produce electricity from the ocean water or large body of water by harvesting some of the uplifting power or action of a water wave or swell. The actual weight of a float being pulled down by gravity on the wave will transfer its weight as the energy to the turbine to produce electricity. The float and float arm on the vessel will be using the simple lever system as a mechanical means to transfer this energy to the water pump. One end of the lever system extending inside the hull of the ship will pump and force fresh and recycled water into a large water reservoir under pressure for use by an electrical turbine on board the vessel . . . . This vessel will carry the total and complete electrical generating station. Severe storms or water action will not affect the delivery of uniform energy towards the generator. Each float is delivering secondary or indirect energy from the waves, not the direct force of a wave, because the float's actual weight from gravity will be the uniform energy necessary to pass on to the electrical station, but not the direct energy from a rising wave.

In actual use: The rising and falling floats located at one end of the lever with their fulcrums attached to the vessel's bow, will move up against gravity on the water wave to capture and store energy. The float's weight, on the down stroke, and sometimes out of and above the receding wave, will transfer this energy at the opposite end of the lever. This lever has an attached connecting rod extending down into the vessel that can either pull the attached piston directly up in a vertical direction to do work or change the stroke of the water piston to a “pushing action” of the water piston by employing a “cam and camshaft” between the water piston and the end of the float's arm. I will use the camshaft method in this invention. This change of direction will cause the water pump piston to be pushed down in the hull instead of being pulled up directly by the connecting rod. One side of the cam will be connected to a float arm with a metal rod. The other end of the cam will be connected to the water piston's shaft, which will then move in the opposite direction as it rotates on the camshaft itself. This camshaft will change the pulling direction to a pushing motion from the force of the connecting rod adhered to the float arm. This pushing action now will transfer the energy from the piston in the water pump to water that will go into a large pressurized holding tank. This water tank now under extreme pressure, will allow water to be forced into the water turbine to generate electricity. This electrical energy will carried to shore with a “submarine” or underwater cable.

Some unique features have been added since the original conception of this invention that I put on paper Apr. 1, 2002, plus simplification for efficient operation and less maintenance for lasting operation of this floating electrical station.

### BRIEF DESCRIPTION OF THE VIEWS OF THE DRAWINGS

Drawing #1

General view of the entire floating electrical station with (6) floats

Drawing #2

General view of a float arm using the vessel's side as a fulcrum with a float at one end and a cam rod connected to the opposite end and within the vessel's hull, to operate a water pump.

Drawing #3

General view and location of two water pumps, water holding tank, turbine, and water lines within the vessel's hull.

### DETAILED DESCRIPTION OF THE INVENTION

### There will be (3) major parts for the invention

#1—Floating ship, hull, or vessel showing side floats

#2—Floats and its hardware

#3—Water piston area and water flow plan

#4—Generator or hydro turbine

A floating (ship or) vessel can be used to produce electricity anywhere in the world where there is some water wave action. The use would be of particular importance for isolated islands needing electricity, or communities on land near the ocean without adequate electricity. The best location for use should be where constant wave or swell action for long periods of time exists.

A variety of cargo vessels with different lengths, widths, and freeboard with open hulls can be used. A cargo ship approx. 300 feet long would be best to carry this electrical station. The open-type vessel with less than 40 feet freeboard is suggested. There is a surplus of vessels worldwide that could be adapted for this use.

The construction would allow for low maintenance, easily floated to a new location, and built of materials to withstand salt water and severe weather conditions. A small fossil fueled motor would perform necessary functions on board, such as raising anchors, maintaining drift, pumping water, emergency electricity, air pressure for raising the floats and maintaining an air supply in the pressurized water tank, etc. Some of the electricity generated by ocean waves might also be used for these tasks also. The floating vessel will be equipped with (6) floats, three on each side, that are moving up vertically from water or wave action. When gravity pulls these floats down, the opposite end of the float will rise up and do work within the vessel. The fulcrum of this lever action is secured on the vessels side, between both ends of the floats arms. A metal rod will tie the upper end of the float's arm to the cam below to change direction from a pulling action to a pushing downward direction. The pushing up action of the water piston will force water into a large pressure tank. The pulling motion of the water piston will pull water back into its chamber to be pushed out again. Water will then be forced by this piston into the large and pressurized water tank as energy. This water tank will force water through a turbine nearby to generate electricity. The electricity generated will then be transferred to shore. An underwater or “submarine” cable would be used, available worldwide.

The vessel should be moved in water by utilizing either towing or pushing boats, consequently the motors, fuel, and original hardware to operate or navigate the vessel could be removed. A vessel with a “no motor” feature, and “gutted out” can be purchased for less money, and would have more room for the new use as an electrical station.

Anchoring the vessel from the bow to the seafloor or lake bottom will help insure the hull of the vessel will “trail” back from the wave action direction to produce the best action for the floats. Extra anchors on this vessel should be required. The hull can also be anchored or fixed stationary to a coastal or lake outcropping, cliff, or other solid anchor point(s) on the shore, or, rising from the ocean or lake bottom. This vessel will be purchased, built, or remodeled to be very stable in the worst of weather, water or extreme storm actions. The ship's “Roll” and pitch action may help the float action. Stabilizing plates for the vessel located in the water could be used perhaps to get more float action from consistent swells or waves, if the vessel is rising excessively with the water waves. The float system will operate however with any wave action. The floats, their support arms, or beams, should be the only parts of this station exposed to the weather. All other mechanical hardware will be below the “deck” area or covered for protection from salt water or weather.

The floats can have a plurality of shapes and sizes, from long and cylindrical, round or rectangular, depending upon water or wave action. Cylindrical floats may be best for carrying a large amount of weight when the wave action is coming from one direction. The shape of the floats will be designed to insure the most lift from a swell or wave, also built to resist high winds or storms. Each float with its attached hardware (including the float arms extending within the vessel) will weigh many tons. An electrical or mechanical engineer, after knowledge of water waves in the area, may choose the floats size and weight to determine the maximum electrical output. The floats will be filled with water, but the water reservoir within the float will hold air to keep them floating, but just above its desire to sink below the surface, and mostly “buried” within the water wave. The water level within the float could be adjusted with a fixed air pipe or hose along the floats arm, so the vessel's auxiliary motor could change its weight for best working weight, or storms, travel, repair, out of service, etc. The floats can be raised mechanically to an “out of service” position anytime. The floats themselves could be made of tough plastic or metal and strapped or adhered securely, or made part of the float arm. Metal could add rigidity and weight. The float arm itself will be of metal, reinforced with cable for strength. The length of the float arm is about 80 feet, adjustable at the extreme, upper end, extendable to about 20 feet more than normal use within the confines of the vessel. In other words the float arm head can be adjusted at any length from 0 to 20 feet longer than its shortest length. This upper end of the float's arm will carry the fixed hardware to push and pull the water piston. The adjustable float arm's head and cable assembly will accomplish two things: #1, It will change the energy the water piston receives from the float's arm, depending upon its length or distance from its fulcrum or axle it pivots upon. It is ideal to have all float arm extensions to be located from the fulcrum evenly on all float arms to help receive and deliver the same energy. #2, the arms can be extended or adjusted to reach or better fit the different widths of different vessels as well as the ship's curved bow, where the float is pivoting and anchored at different locations. Any extra weight added to this upper end of the float arm should be added to the lower end of the float arm, or the float, to help enhance the weight of this lower arm so maximum energy can be passed to the primary cylinder.

The float's arm should be approx. 80 feet long, with its fulcrum or pivoting axle, approx. 53.3 feet from the extreme lower end of the float in the water to the side or bow of the ship. The final 26.7 feet will be extended inside the vessel from this pivot point, but note it has another approx. 20 feet, if needed, with its extension head. The float should have three support arms. The main and centrally located float arm will begin on the top and center of the float in the water, or at its farthest point from the vessel. The two separate supporting side arms for this float will also start (or end) on this topside of the float. From here, the side support arms will widen to a maximum width of approx. 40 feet away from where the center support arm is positioned on the ship's bow. This 80 foot float support with its three arms will all share the same fulcrum or axle that is mounted upon the vessel's bow. The 40 feet of width allows the three arms of the float to be anchored at three places on one main axle. The center arm will be the strongest, as it must carry the major weight of the float plus the arm's weight extending beyond the fulcrum to the center of the vessel. This center arm carries the heavy hardware to do the work. This float arm will support those two separate “side” arms of the float that will help prevent twisting, or other damage due to the violent wave action and will be secured or fixed or become permanently attached to each other as one unit, and will be adhered permanently to the fulcrum's axle. The cylindrical axle thus attached and holding up all three attached float arms, but at separate locations, will be the fulcrum for the float as it moves up and down. The fulcrum or axle holding the heavy float arms will be attached very strongly to the vessel to prevent damage in the extreme low and high positions as well as the vessels pitch and roll actions. Again, the two side arms of the float should be securely held to the main center arm of the float to help withstand the twisting or damaging effect of the water, weather, etc.

When the floats are in the lower than normal position, they may stop upon hitting the side of the hull on a large vessel. An additional padding material of softer very resilient material could be permanently placed on the float's underside making contact to the hull, or the out of service cable to raise the floats could be used as the stopping point if needed occasionally. On a small vessel, a cushion could be placed under the float arm to contact the hull of the vessel, if ever necessary, in a gentle manner. These cushions should have special shock absorbing qualities. The hull may have to be reinforced where it may contact the hull at this lowest float position if necessary.

Each float on the vessel should maintain the same weight for producing the same energy or power. When mounting the working floats from the bow to the stem of a vessel, different distances from the bow to the centerline of the vessel will occur. The floats fulcrum or pivoting axles may be moved to conform to the rounding hull, or have the extendable heads used which would change the distance to the center of the vessel, but, again, would not matter. It is necessary to have these axles holding the floats be parallel to each other, or on the same horizontal plane.

The following paragraphs describe the fulcrum or pivoting axle for the floats on a 300 foot or longer vessel.

The total length of the axles that are inside and not the “end” axles holding the floats in place should be 45 feet. The “end” axles can be 50 feet, but a minimum of 47.5 feet. There will be room for (3) floats on each side, rotating on an axle or fulcrum totaling 240 feet (each side), or 80 feet for each float. The diameter of the axle or fulcrum should hold the floats weight and hold the pitch and roll stress during extreme weather. There will be two bearings and bearing caps on the axle between the two outside arms of the float. Between each float's outside arm there will be another bearing and cap separating these two arms. The axles will be split here for separate rotation for each float assembly containing the three float arms of each float. The bearing and cap should have a stop groove so each axle won't move horizontally. All bearings should be alike, except the two end bearings, which will not have a split axle in them. The axle will be rigidly supported from the bottom and sides of the vessel to hold the extreme weight of the floats, the float's support arms, and hardware. There will be a framework of steel perhaps coming from the floor of the vessel, as the base, to hold the float arms and the rotating axles. These axles must be high enough for the float arms to clear the top of the hull when moving up and down. The framework to block up the float's arm on the bow can be of different height or thickness, but mounted primarily to support the float arms and secondly to clear the top of ship's hull when the floats are at their lowest and highest positions.

### In the Vessel's Hull:

The connecting rod at the end of the float arm that is extended downward within the vessel's hull is working within a steel pipe or cylinder in the vertical up and down direction and its distance of travel is dictated by the height of the wave at the other end of this float arm. This action will pump water under pressure to a main line on this side of the vessel that all three float areas and water pumps are using together. This water line will go to the large, high pressure tank that will then keep supplying the turbine with high pressured water at an even rate. After the water has passed through the turbine, it will pool up in a small reservoir, then flow by gravity in one pipe that is shared by each side of three working water pump stations. This will help disallow air to entrain itself into the water. The pressurized water tank can be placed at any elevation that is close to the turbine, but the turbine must be placed above the recycled water supply and return water pipe to the water pumps for gravity to flow the water back to the water pumps. There can be several methods used to supply the water from the piston to the water tank receiving the water pressure. This invention will use the following water pipe and valve plan:

There will be only one collector pipe on each side of the vessel that will transfer the high pressure water from all three water pumps on their respective side to the water holding tank. This one pipe will collect all water pumped from one side of the vessel from the three water pumps and deliver it into the holding tank. There will be “check valves” installed close to the water pump and for extra safety, close to the holding tank also, so water pressure is not lost. Water used by turbine will be recycled and collected in a small lagoon, or open tank type structure. There will be only one recycled water pipe from the base of this water reservoir to supply all three water pistons on their respective sides. This water will be fed to the pumps from the force of gravity. There is the possibility that for reasons of placement, or location of the turbine, a closed pipe system using some of the water pressure from the water tank could be used to force the water to the pumps for its re-use.

### Water Pumps:

There are pluralities of water pumps that can be used, however, I will use the following one in this invention. The water pump will consist of a water piston, a connecting rod from it to the camshaft's cam, and the pipe or metal cylinder it is fitted into. The water piston's cylinder is secured to the bottom of the vessel at the correct elevation for the water piston to operate in at a safe length so that the piston will not touch the chamber's extreme end. This cylinder or water pipe will extend upwards to the cam, but not to touch or contact it when the piston is at its extreme position due to high water wave action. Both the high pressure valves and water return check valves are located below the head of the piston. This will allow the top of the piston's cylinder to be open for the connecting rod from the float's arm to work and not touch the cylinder wall. It will also allow any excessive water forced around the piston rings from pushing water to be expelled for recycling. 12 or more inches of water should be sufficient above, or behind the piston to disallow any air to be sucked along the walls of the piston while it is sucking in water from the front of the head.

### The Camshaft:

(To change direction of the energy from the float arms)

The camshaft tower should be welded to the bottom hull of the vessel and directly below the end of the upper float arm area. There will be extreme force on the cam-shaft to be lifted upwards due to the heavy weight of the float. The bottom half of the cam and the cam-shaft will be made strong with heavy metal to withstand this force. The top half of the covering on the cam-shaft need only to hold the camshaft together properly.

1. I claim that the use of a cargo vessel or a ship anchored in the ocean carrying side floats and producing electricity with fresh water through a water turbine inside the vessel's hull from the energy of water waves is new.

2. I claim that by using a float and a float's rigid arm in a new way as a simple class #1 simple lever system with the float on the water at one end, and its fulcrum anchored and rotating on the bow of a floating ship or vessel, and the opposite end with a vertical rod extending downward into the ship's hull to operate a water pump that recycles fresh water within this hull is new.
